(19) United States
(12) Patent Application Publication
(10) Pub. No.: US 2001/0043156 A1
(43) Pub. Date: Nov. 22, 2001

(54) Transmitting-receiving station for radio wave diversity inside building

(76) Inventors: Teruo Matsui, Tokyo (JP); Keisuke Oda, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/849,974

(22) Filed: May 8, 2001

(30) Foreign Application Priority Data
May 9, 2000 (JP) 135769/2000

(51) Int. Cl. G01S 5/02

(52) U.S. Cl. 342/417

(57) ABSTRACT

A transmitting-receiving station for use in radio wave diversity comprises two antennas (21, 31), a distributor-composer (30), and a transceiver (40), and tarder comprises a phase prefixed-adjuster (22), a level prefixed-adjuster (23), and a delayed prefixed-adjuster (24) as one of prefixed adjusters supplied between the antenna (21) and the distributor-composer (30). The two antennas have a predetermined distance therebetween for use of space-diversity. The distributor-composer connects to the two antennas on one side and a transceiver on the other side, distributes a signal to be transmitted from the transceiver, and composes two signals to be received from the two antennas. The prefixed adjuster manually adjusts and fixes each two values of phases, levels, and delay times of the signals dependent of the two antennas respectively so as to be made the same value each other on a connecting point of the distributor-composer. The phase prefixed-adjuster has a construction being adjustable by slightly moving a position of an antenna connecting thereto to front and rear in a direction of the radio signal and performs an adjusting to the same phases each other. The level prefixed-adjuster comprises a plurality of fixed attenuators being set a level selection. The delay prefixed-adjuster comprises a plurality of fixed delay elements being set a level selection. By such composure, the prefixed adjuster easily controls a difference between signals receiving from two antennas respectively within a predetermined value for each of the phase, the level, and the delay. The prefixed adjusters may be supplied also between the antenna (31) and the distributor-composer (30).

### BACKGROUND OF THE INVENTION

This invention relates to a transmitting-receiving station for use in radio wave diversity comprising two antennas having a predetermined distance therebetween for use of space-diversity, a distributor-composer, and a transceiver. The distributor-composer distributes a signal transmitted from the distributor-composer, composes two signals received from the two antennas respectively, and connects with the antennas on one side and the distributor-composer on the other side.

Herein, it is to be noted that the communication is established between one station installed inside a building and the other station facing thereto. That is, the station is capable of maintaining a good quality on the radio channel even if a metal shield blocks off radio signals on a transmission path connected with one of the antennas. The station is further capable of improving simplification and economization of a structure of the station.

There are cases, for example, that the transmitting-receiving station for use of a digital radio channel within microwave frequency band is installed in a building room and communicates with the facing station through a window. A gondola for cleaning the windows should have a chance blocking off the transmission path of the radio signal between such the stations as described above. In such case that only one of the antennas is being provided, the quality of the radio channel is deteriorated.

In order to improve the quality deterioration of the radio channel, it is effective that a space-diversity composes signals received from two antennas installed having some distance as space.

An existing transmitting-receiving station for use in diversity transmission/reception, as shown in FIG. 1 for example, receives a signal sent through an antenna 11 from a transceiver 10 in a facing station by two antennas 121 and 131. A phase adjuster 122 or 132, which includes a phase shifter and is connected to the antenna 121 or 131, electrically adjusts the phases of the signal, and then sends the signal to a composer 130.

The composer 130 composes the two receiving signals by equivalent gain, controlling electrically a difference between receiving levels. Further, in order to suppress influence small at a time of the composing for indirect waves such as reflection waves having any delay time difference or the like each other, the composer 130 always supervises an amplitude-frequency characteristic within transmission band for a composed signal. And the composer 130 disposes received signals by electrical and electronic control to make an amplitude deviation minimum. Then, the composer 130 sends the composed signal to a transceiver 40.

The existing transmitting-receiving station for use in diversity described above composes phases, levels, and delay times for two signals received from two antennas, respectively, by automatically controlling electrically and electronically so as to eliminate any difference thereof. As a consequence, the structure of the transmitting-receiving station described above is complicated and the economization thereof is insufficient,

### SUMMARY OF THE INVENTION

It is therefore an object of the present invention to provide a transmitting-receiving station for use in radio wave diversity, which enables simplification of structure and improvement of economization thereof.

According to the present invention, there is provided a transmitting-receiving station for use in radio wave diversity, which comprises two antennas, a distibutor-composer, and a transceiver, and further comprises at least one of prefixed adjusters supplied between any one of the antennas and the distributor-composer. The prefixed adjuster manually adjusts and fixes each two values of phases, levels, and delay times of the signals dependent of the two antennas respectively so as to be made the same value each other on a connecting point of the distributor-composer.

The two antennas have a predetermined distance therebetween for use of space-diversity. The distributor-composer connects to the two antennas on one side and a transceiver on the other side, distributes a signal transmitted from the transceiver, and composes two signals received from the two antennas.

As described above, adjusting is achieved by manually fixing without any automatically electrical or electronic control. Consequently, the transmitting-receiving station having such prefixed adjuster is able to make its structure simple and economy.

The prefixed adjuster comprises a phase prefixed-adjuster, a level prefixed-adjuster, and a delayed prefixed-adjuster serially connected. The phase prefixed-adjuster has a construction being adjustable by slightly moving a position of an antenna connecting thereto to front and rear in a direction of the radio signal and performs an adjusting to the same phases each other. The level prefixed-adjuster comprises a plurality of fixed attenuators being set a level selection. The delay prefixed-adjuster comprises a plurality of fixed delay elements being set a level selection. By such structure, the prefixed adjuster easily controls a difference between signals receiving from each of two antennas within a predetermined value for each of the phase, the level, and the delay time.

There is a case that the antennas are laid inside building or the like and then any communication is performed with an opposite side thereby. In this case, easy adjustment is necessary without any deterioration for a radio channel quality even if a metal shield blocks off the radio signal of the transmission path for one of the two antennas. For this purpose, it is preferable that the phase prefixed-adjuster adjusts the phases to the same value by a fine control, the level prefixed-adjuster adjusts a level difference value within 10 ds, and the delayed prefixed-adjuster adjusts a delay time difference value within 1.01 ns.

As a result, it is possible to achieve the object, i.e., to satisfy simplification of structure and improvement of economization of the transmitting-receiving station for use in radio wave diversity.

### BRIEF DESCRIPTION OF THE DRAWINGS

FIG. 1 is a block diagram of an existing system;

FIG. 2 is a block diagram of a transmitting-receiving station according to an embodiment of the present invention;

FIG. 3 is a detailed block diagram of an invented portion of the transmitting-receiving station shown in FIG. 2;

FIG. 4 is a schematic view showing a positioning relation between one of antennas and a metallic shelter in case of bigger level difference in a receiving electric field before the shelter blocks off a radio channel of the antenna;

FIG. 5 is a schematic time chart showing an amplitude frequency characteristic together wit a notch interval after sheltering for the case shown in FIG. 4;

FIG. 6 is a schematic view showing a positioning relation between one of antennas and a metal shield in case of smaller level difference in a receiving electric field before the shelter blocks off a radio channel of the antenna;

FIG. 7 is a schematic time chart showing an amplitude frequency characteristic together with a notch interval after sheltering for the case shown in FIG. 6; and

FIG. 8 is a block diagram of a transmitting-receiving station according to another embodiment of the present invention.

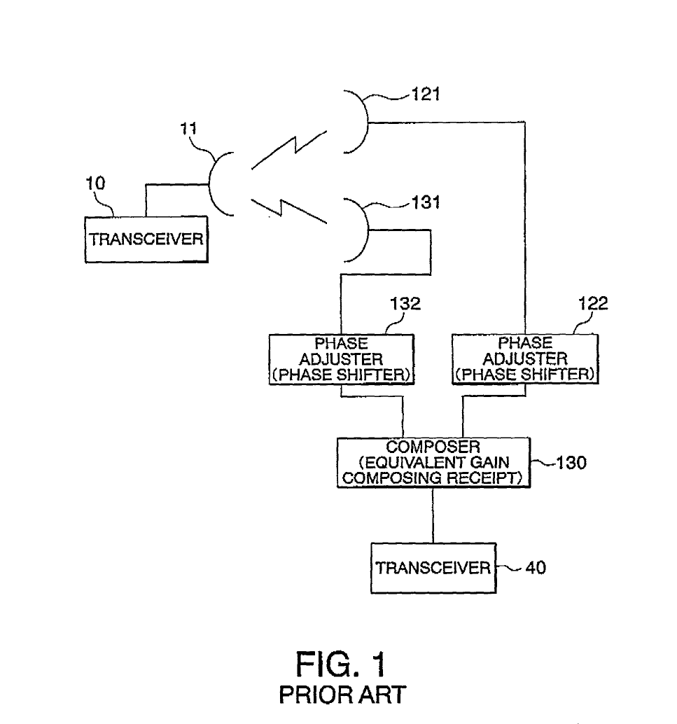

### DESCRIPTION OF THE PREFERRED EMBODIMENT

Now, several preferred embodiments of the present invention will be described with reference to the drawings.

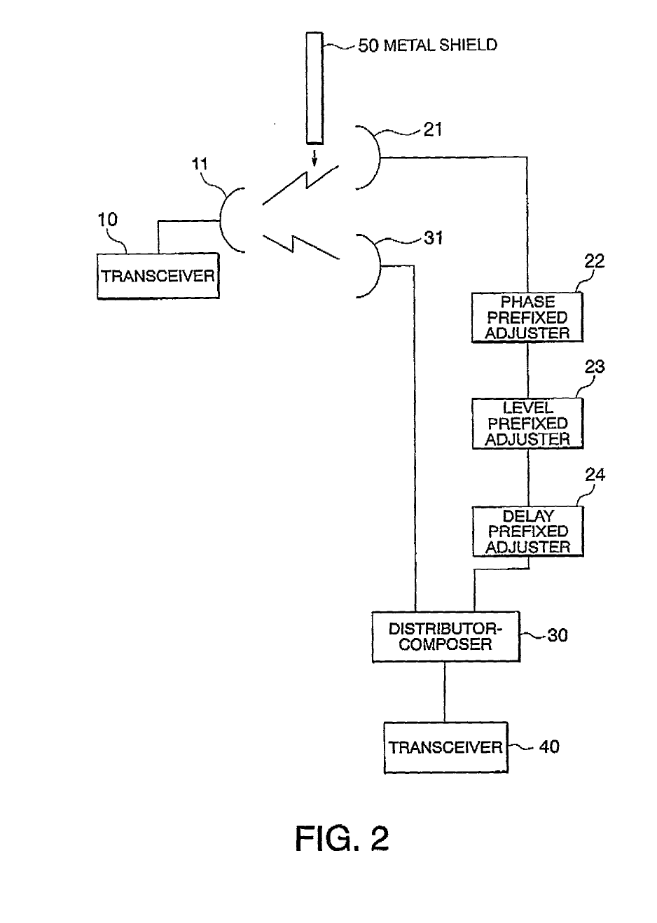

Referring to FIG. 2, a transmitting-receiving station for use in radio wave diversity according to one embodiment of the present invention comprises two antennas 21 and 31, a distributor-composer 30, and a transceiver 40, and further comprises three prefixed adjusters supplied between an antenna 21 and the distributor-composer 30.

The two antennas 21 and 31 have a predetermined distance therebetween for use of space-diversity and receive and send signals sent and received through antenna 11 from a transceiver 10 installed on the other side thereof. The three prefixed adjusters are a phase prefixed-adjuster 22, a level prefixed-adjuster 23, and a delayed prefixed-adjuster 24, which are serially connected.

The antenna 21 connects with the phase prefixed-adjuster 22. The distributor-composer 30 directly connects with the delayed prefixed-adjuster 24 and the antenna 31 on the same side for signal direction and connects with the transceiver 40 on the other side.

The transmitting-receiving station is capable of use of structure elements having reciprocity for all of transmitting and receiving. Consequently, description only for the receiving signal will be presented. Because, as the reciprocity is satisfied in the transmitting and receiving signals, description of the transmitting signal is the same as the description of the receiving signal. Accordingly, the description of the transmitting signal will be omitted.

At a time of installation of the transmitting-receiving station according to the present invention, an adjustment person manually adjusts the prefixed adjusters to accord mutually respective values in two input points of the distributor-composer 30 connected to the antennas 21 and 31 respectively. And then the adjustment person fixes their prefixed adjustments.

In the prefixed adjusters, the adjustment person adjusts an electrical length of one wave-length or less using the phase prefixed-adjuster 22, receiving level using the level prefixed-adjuster 23, and an electrical length more than one wave-length using the delayed prefixed-adjuster 24 respectively.

Therefore, the two radio signals received from two antennas 21 and 31 respectively are made a radio signal adjusted to the same values of the phase, the level, and the delay time and sent to the distributor-composer 30. And the radio signal is sent from the distributor-composer 30 to the transceiver 40. On the other hand, a signal from the transceiver 40 is transmitted through the distributor-composer 30 to the antennas 21 and 31. However, the signal transmitted from the antenna 21 is adjusted by the phase prefixed-adjuster 22, the level prefixed-adjuster 23, and the delayed prefixed-adjuster 24, each of which is set up at a predetermined value manually by a adjustment officer.

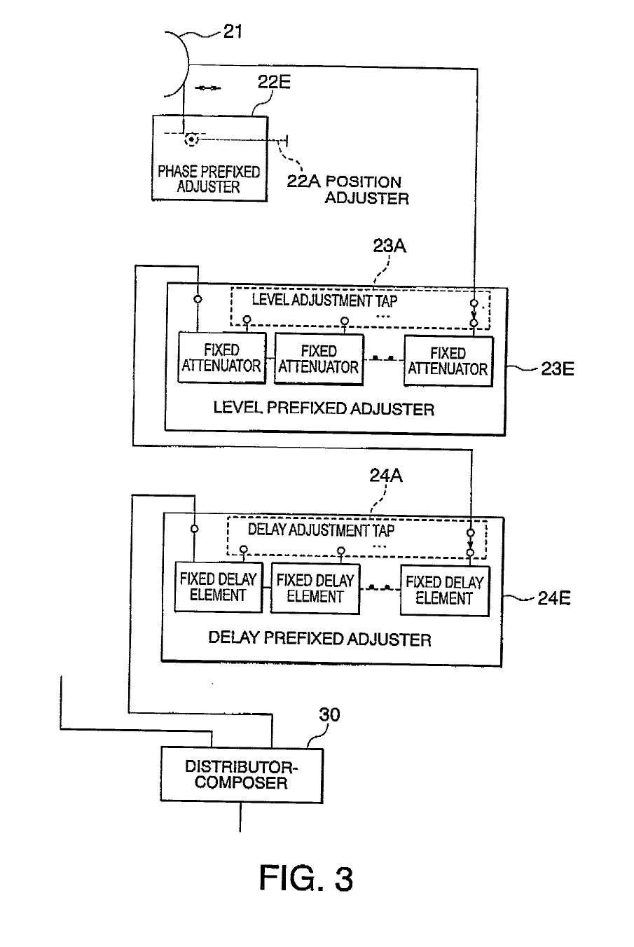

Referring to FIG. 3, description will be made of each of the three prefixed adjusters according to each embodiment of the present invention.

As shown in FIG. 3, the phase prefixed-adjuster 22E has a phase adjuster 22A which is possible finely to move in a transmission direction of the radio signal by using a worm gear for example. It is able to make the phase change to change transmission length of the radio wave in the air space by moving a setting position of the antenna 21. As a result, two receiving signals can adjust one of phases with the other one. As the other phase prefixed-adjuster, we are able to use a variable phase shifter of coaxial type or waveguide type capable of adjusting manually an electrical length of the transmission path for the signal received on the antenna.

The level prefixed-adjuster 23E has a level adjustment tap 23A comprising several taps connected with fixed 1 dB attenuators respectively and possible to adjust a level by switching connection thereof for example. The attenuators are serially connected. The delayed prefixed-adjuster 24E has a delay adjustment tap 24A comprising several taps connected with fixed delay elements respectively and possible to adjust a delay time by switching connection thereof for example. The fixed delay elements serially connected. Consequently, each difference value of the levels and the delay times for the two signals is adjustable within a predetermined one.

Consequently, referring to FIGS. 2 to 7, description will be made of observation results of the adjusting values in the three prefixed adjusters according to the present invention in scope of no deterioration for a quality of a radio channel. The description concerns a case that the antennas are laid inside building or the like and then any communication is performed with an opposite side thereby and even if a metal shield blocks off a transmission path of a radio signal for one of the two antennas.

As shown in FIG. 2, in a transmitting-receiving station for use in radio wave diversity according to the present invention, a transceiver 40 adapting to 22 GHz/6 Mbps is used, and a metal shield 50 is arranged so as to block off a radio signal receiving on the antenna 21. The radio channel quality is observed by moving of the metal shield 50 and changing parameters of the phase prefixed-adjuster 22, the level prefixed-adjuster 23, and the delayed prefixed-adjuster 24 respectively.

Regarding the phase difference, the phase is adjusted so as to avoid any anti-phase point, because a receiving level becomes zero after composing two receiving signals having the anti-phase each other As the results of the verification for level differences of the receiving electrical field, it is confirmed that the smaller difference makes the fewer influence of the metal shield as described below.

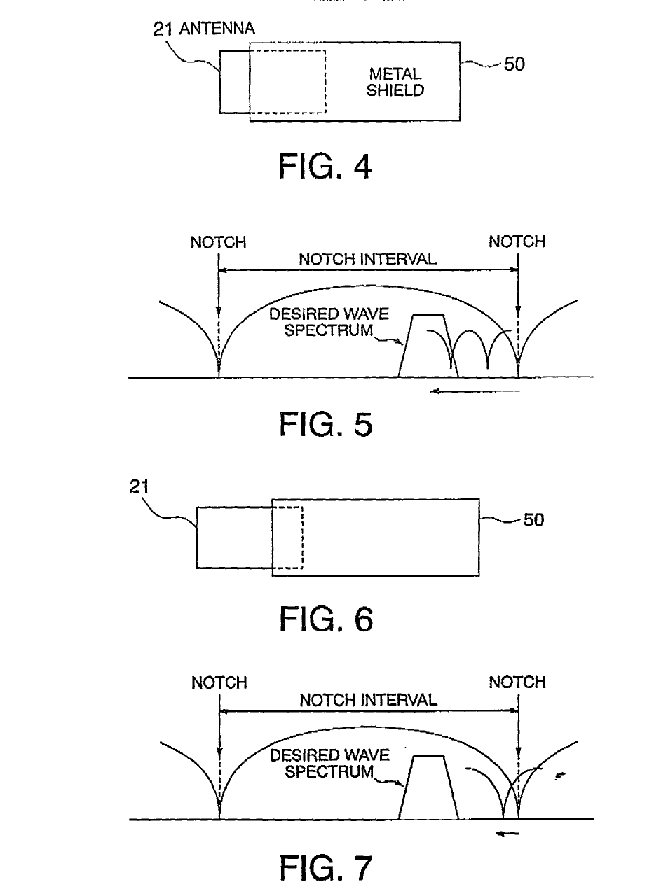

We will take up a case that the antenna 21 has a big level difference of the receiving electric field, where the level in the antenna 21 is higher than that in the antenna 31. At a time that the metal shield 50 blocks off almost portion of the antenna 21 as shown in FIG. 4, the both levels of antennas 21 and 31 are the same one. In such situation, as the phase falls into disorder in the radio wave reaching to the receiving antenna 21, a notch of the composed signal moves over big range on the frequency axis and an in-band amplitude deviation of a desired wave is made large as shown in FIG. 5. Accordingly, the radio circuit quality is easy to deteriorate.

On the contrary, there is a case the antenna 21 has a small level difference of the receiving electric field, where the level in the antenna 21 is higher than that in the antenna 31. At a time that the metal shield so blocks off small portion of the antenna 21 as shown in FIG. 6, the both levels of antennas 21 and 31 are the same ones. In such situation, as the distortion of the phase is small in the radio wave reaching to the receiving antenna 21, a notch of the composed signal moves little on the frequency axis as shown in FIG. 7. As a result an in-band amplitude deviation of a desired wave is made small. Accordingly, the radio circuit quality is difficult to deteriorate.

Also, regarding the delay time difference, we have been able to confirm that the smaller difference makes the less deterioration on the radio channel quality.

Generally, a notch interval is an inverse number of the delay time difference. This means that the notch interval is small and the in-band amplitude deviation of a desired wave makes large in case of the large delay time difference. In this case, it has had bad influence upon the radio channel quality. In the case of the small delay time difference, the notch interval is large and the in-band amplitude deviation of a desired wave makes small. Accordingly, this brings about only few influences upon the radio channel quality.

In the observation of this time, we adjusted the three adjusters as follows. The phases of the receiving signals transmitted from the antenna 11 are adjusted to the same in the antennas 21 and 31 respectively. The level difference of the receiving electrical field is adjusted within 10 dB upon the two antennas 21 and 31 before sheltering by the metallic shelter 50. And the delay time difference is adjusted within 1.01 ns being appropriate to within 0.3 m on a transmission path of a free space, on the signal transmission paths from the antenna 11 to the antennas 21 and 31. In this situation, we could confirm that the radio channel quality is not deteriorate even if the metal shield 50 blocks off a transmission path in front of the antenna 21 or 31.

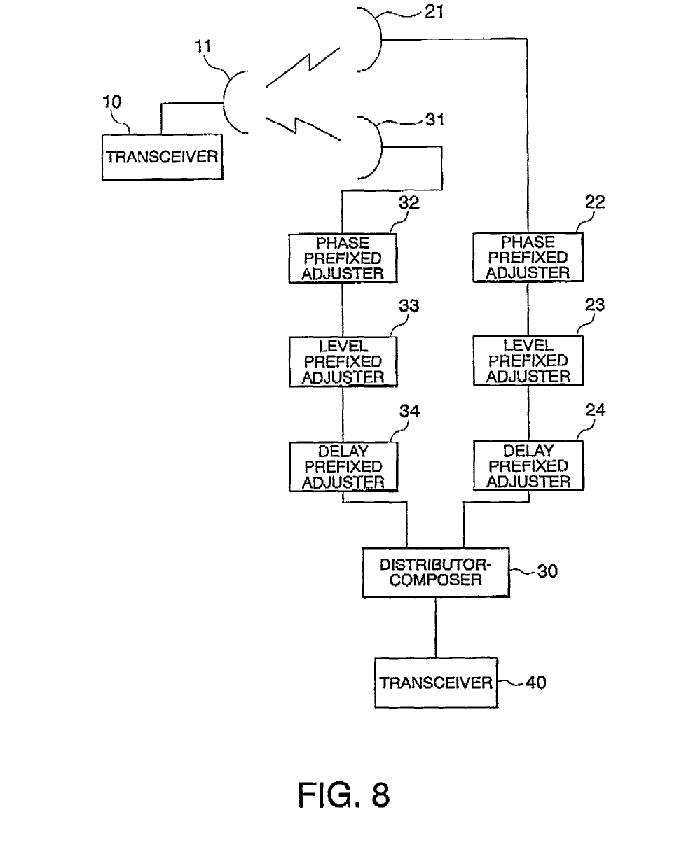

Referring to FIG. 8, description will be made of a transmitting-receiving station according to another embodiment of the present invention from FIG. 2.

The different points of FIG. 8 from FIG. 2 is that a phase prefixed-adjuster 32, a level prefixed-adjuster 33, and a delayed prefixed-adjuster 34 are further supplied between the distributor-composer 30 and the antenna 31 as same as between the distributor-composer 30 and the antenna 21. The phase prefixed-adjuster 32, the level prefixed-adjuster 33, and the delayed prefixed-adjuster 34 having a manual adjuster respectively as described referring to FIG. 3 can more flexibly correspond to adjustment of phase, level, and delay time on the antenna connection side of the distributor-composer 30.

While the present invention has been described in detail in conjunction with the several preferred embodiments thereof, the present invention is not limited to the foregoing description but can be modified in various manners without departing from the scope of the invention set forth in appended claims.

As apparent from the foregoing description, according to the present invention, the transmitting-receiving station for use in radio wave diversity comprises at least one of prefixed adjusters supplied between any one of the antennas and the distributor-composer. The prefixed adjuster manually adjusts and fixes each two values of phases, levels, and delay times of the signals dependent of the two antennas respectively so as to be made the same value each other on a connecting point of the distributor-composer.

With this structure, it is possible to achieve the object, i.e., to enable simplification of structure and improvement of economization thereof. Furthermore, by the structure elements having reciprocity, it is possible to obtain the same effect for a transmitting signal also.

What is claimed is:

1. A transmitting-receiving station for use in radio wave diversity comprising two antennas having a predetermined distance therebetween for use of space-diversity, a distributor-composer and a transceiver; further comprising:
at least one of prefixed adjusters supplied between any one of said antennas and said distributor-composer, manually adjusting and fixing each two values of phases, levels, and delay times of the signals dependent of said two antennas respectively so as to be made the same value each other on a connecting point of said distributor-composer.

2. A transmitting-receiving station for use in radio wave diversity; comprising:
two antennas having a predetermined distance therebetween for use of space-diversity;
a distributor-composer connecting to said two antennas on one side, distributing a signal to be transmitted from said transceiver, and composing two signals to be received from said two antennas;
at least one of prefixed adjusters supplied and connected with any one of the antennas, manually adjusting and fixing each two values of phases, levels, and delay times of the signals dependent of the two antennas respectively so as to be made the same value each other on a connecting point of said distributor-composer; and
a transceiver connecting to the other side of said distributor-composer.

3. A transmitting-receiving station according to claim 2, wherein said prefixed adjuster comprises a phase prefixed-adjuster, a level prefixed-adjuster; and a delayed prefixed-adjuster serially connected.

4. A transmitting-receiving station according to claim 3, wherein said phase prefixed-adjuster has a construction being adjustable by slightly moving a position of said antenna connecting thereto to front and rear in a direction of the radio signal and performs an adjusting to the same phases each other.

5. A transmitting-receiving station according to claim 3, wherein said level prefixed-adjuster comprises a plurality of fixed attenuators being set a level selection.

6. A transmitting-receiving station according to claim 3, wherein said delayed prefixed-adjuster comprises a plurality of fixed delay elements being set a level selection.

7. A transmitting-receiving station according to claim 3, wherein said phase prefixed-adjuster adjusts the phases to the same value by a fine control, said level prefixed-adjuster adjusts a level difference value within 10 dB, and said delayed prefixed-adjuster adjusts a delay time difference value within 1.0 ins.
